(19) United States
(12) Patent Application Publication
(10) Pub. No.: US 2017/0023183 A1
(43) Pub. Date: Jan. 26, 2017

(54) FLUID ACCELERATION PIPE

(71) Applicants: NAN-CHI CHEN, Changhua County (TW); WANG-CHUN CHEN, Changhua County (TW); CHIEN-HUNG CHEN, Changhua County (TW)

(72) Inventors: NAN-CHI CHEN, Changhua County (TW); WANG-CHUN CHEN, Changhua County (TW); CHIEN-HUNG CHEN, Changhua County (TW)

(21) Appl. No.: 15/282,527

(22) Filed: Sep. 30, 2016

Related U.S. Application Data
(63) Continuation-in-part of application No. 14/285,690, filed on May 23, 2014.

(51) Int. Cl. F17D 1/07; F15D 1/00

(52) U.S. Cl. CPC F17D 1/07; F15D 1/003

(57) ABSTRACT

The fluid acceleration pipe includes a main body having a pipe cavity and defining a central axis. The whole inner surface of the main body is exposed to the pipe cavity. The main body is formed with at least 3 spiral ribs arranged spacedly along a perimeter direction of the main body. A spiral groove is formed between any two adjacent ones of the spiral ribs. A column-shaped imaginary datum plane is defined by the most bottom portion of each spiral groove about the central axis. A projection of the most top portion of each spiral rib on the imaginary datum plane defines a spiral line. The lead angle of the spiral line is 50 to 60 degrees. The top portion of each spiral rib has a convex-arc-shaped surface, and the bottom portion of each spiral groove has a concave-arc-shaped surface.

### BACKGROUND OF THE INVENTION

Field of the Invention

The present invention is a CIP of application Ser. No. 14/285,690, filed May 23, 2014, the entire contents of which are hereby incorporated by reference.

Description of the Prior Art

Lots of air compressors are used in the mechanical field. Air compressors are absolutely necessary in sites such as factory, automobile service factory, decoration & construction etc. However, the compressor power of an air compressor needs typically electric power or fuel oil. Therefore, if sufficient compression air may be accumulated in shortened shorter time, partial electric power or fuel oil may be saved relatively to achieve the effect of energy saving. It is still under development to achieve such a goal.

On the other hand, if accelerated pressurization is available for the output of compression air, the pressure may be increased definitely. Thereby, the air with larger pressure may be provided by a smaller compressor. Therefore, a smaller compressor may be purchased to reduce the equipment cost in procuring a compressor.

On a further hand, there are two styles for accelerated pressurization, one is power accelerated pressurization, and the other is natural accelerated pressurization. The power accelerated pressurization needs precise adjustment, and has to consider power quality, too. Further, the natural accelerated pressurization is the optimal option because there is no energy consumption problem, no adjustment, no need of power, which results in no need to consider power quality.

### SUMMARY OF THE INVENTION

The main object of the present invention is to provide a fluid acceleration pipe to accelerate fluid flowing therethrough.

To achieve the above and other objects, a fluid acceleration pipe of the present invention includes a main body.

The main body has a pipe cavity and defines a central axis. The whole part of an inner surface of the main body is exposed to the pipe cavity. The main body is formed with at least 3 spiral ribs arranged spacedly along a perimeter direction of the main body. A spiral groove is formed between any two adjacent ones of the spiral ribs. An imaginary datum plane is defined by a most bottom portion of each spiral groove about the central axis. The imaginary datum plane is column-shaped. A projection of a most top portion of each spiral rib on the imaginary datum plane defines a spiral line. The lead angle of the spiral line is 50 to 60 degrees. The top portion of each spiral rib has a convex-arc-shaped surface, and the bottom portion of each spiral groove has a concave-arc-shaped surface.

To achieve the above and other objects, the fluid acceleration pipe of the present invention further includes an outer sleeve. The outer sleeve is sleeved onto the main body and is rotatable with respect to the main body.

Thereby, the present invention gives the accelerated fluid, such as liquid or gas, a higher flow speed and a higher pressure. When the present invention is used in other machines, energy for pressurizing the fluid can be saved.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a partial stereogram of the present invention;

FIG. 3 is a front view of the present invention;

FIG. 4 is a stereogram of the present invention at another angle;

FIG. 5 is a lateral view of the present invention;

FIG. 6 is an illustration of the present invention;

FIG. 7 is a stereogram showing a second embodiment of the present invention.

### DETAILED DESCRIPTION OF THE PREFERRED EMBODIMENTS

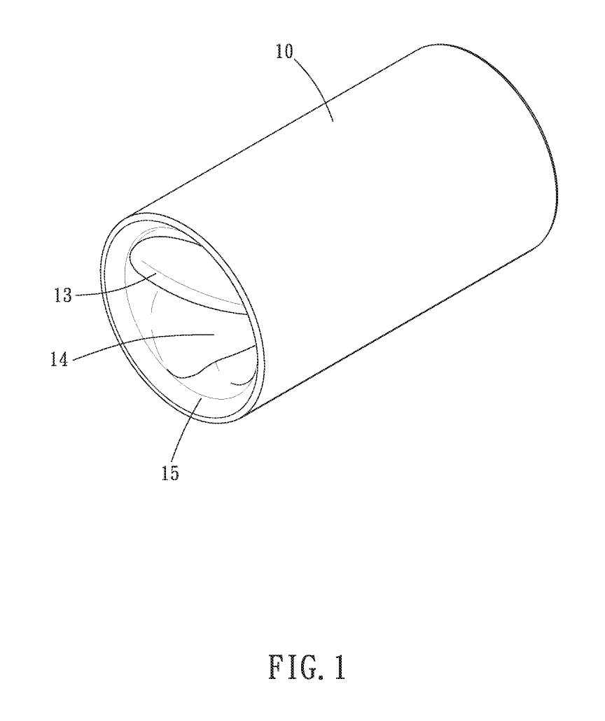

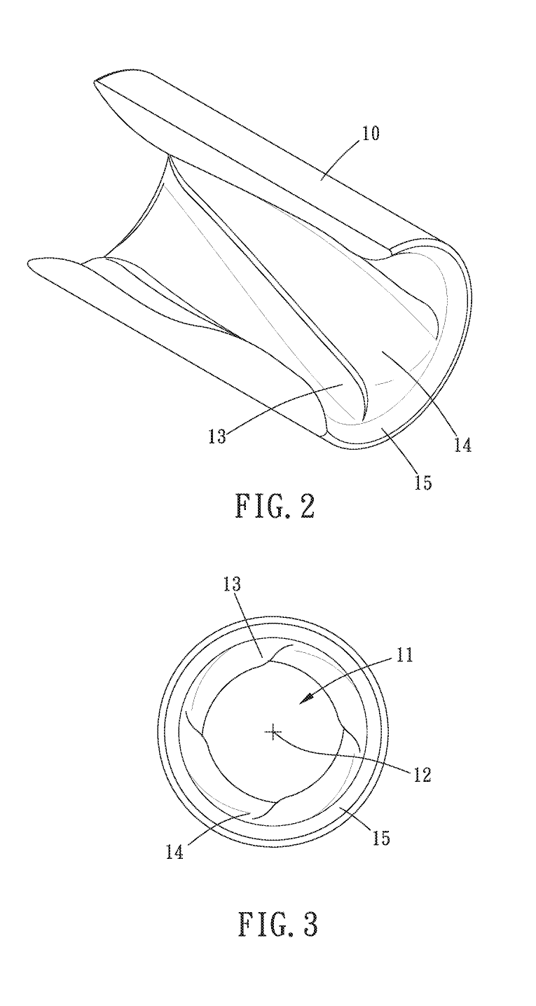

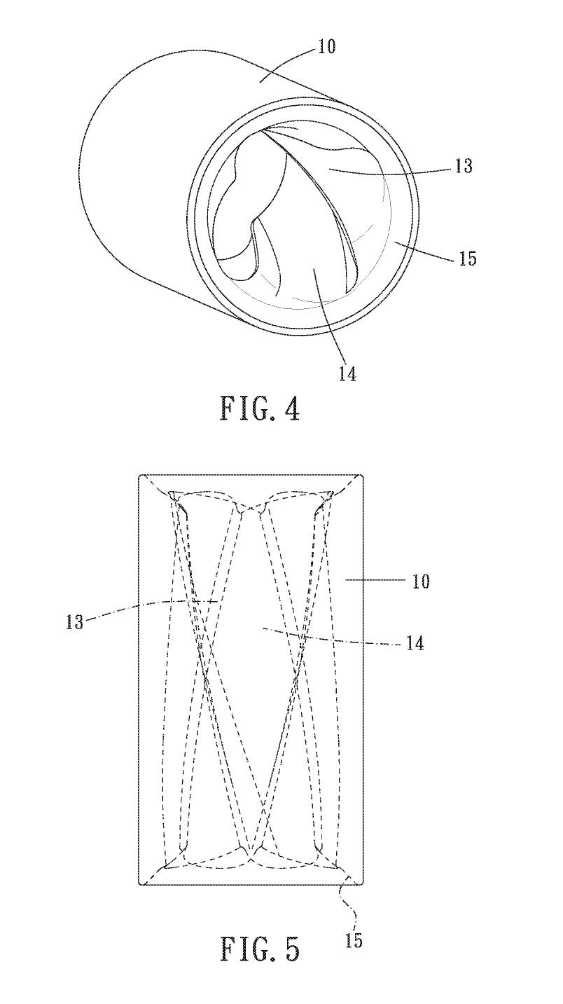

Please refer to FIG. 1 to FIG. 6, the fluid acceleration pipe of the present invention includes a main body 10.

The main body 10 has a pipe cavity 11 and defines a central axis 12. A whole part of an inner surface of the main body 10 is exposed to the pipe cavity 11. The main body 10 is formed with at least 3 spiral ribs 13 arranged spacedly along a perimeter direction of the main body 10. A spiral groove 14 is formed between any two adjacent ones of the spiral ribs 13. An imaginary datum plane P is defined by a most bottom portion of each spiral groove 14 about the central axis 12. The imaginary datum plane P is column-shaped. A projection of a most top portion of each spiral rib 13 on the imaginary datum plane P defines a spiral line L. The lead angle α of the spiral line L is 50 to 60 degrees. The top portion of each spiral rib 13 has a convex-arc-shaped surface, and the bottom portion of each spiral groove 14 has a concave-arc-shaped surface.

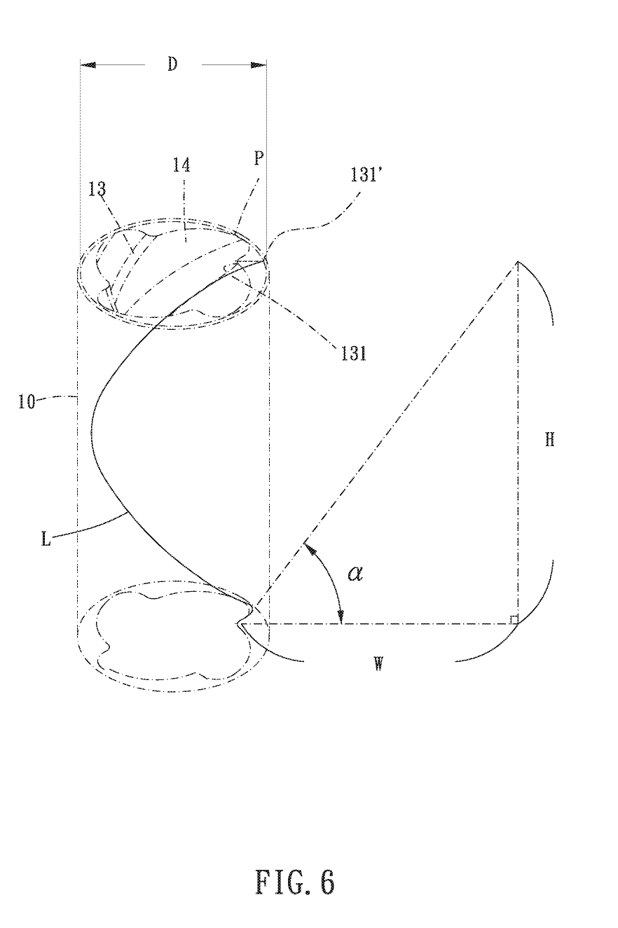

In view of the lead angle α of the spiral line L is reached by some simple calculations. Please refer to FIG. 6, H is the height of the main body 10 when the spiral line L goes a complete loop, and W is the perimeter of the imaginary datum plane P. W can be reached from the equation W=πD wherein D is the inner diameter of the imaginary datum plane P. Thereby, the lead angle α can be reached from the equation tanα=H/W. Preferably, the lead angle α of each spiral line L is 53 to 56 degrees.

In the present embodiment, the main body 10 further has a diverging portion 15 at each of openings of the pipe cavity 11. The spiral ribs 13 and the spiral grooves 14 do not extend to the diverging portions 15. The inner diameter of each diverging portion 15 is larger than the inner diameter of the imaginary datum plane P and is increasing outward.

Preferably, a height of each spiral rib 13 is defined as a distance from the top portion of the spiral rib 13 to the imaginary datum plane P, and the height of each spiral rib 13 is 0.15-0.27 times the inner diameter of the imaginary datum plane P. Thus, the performance of acceleration can be further improved.

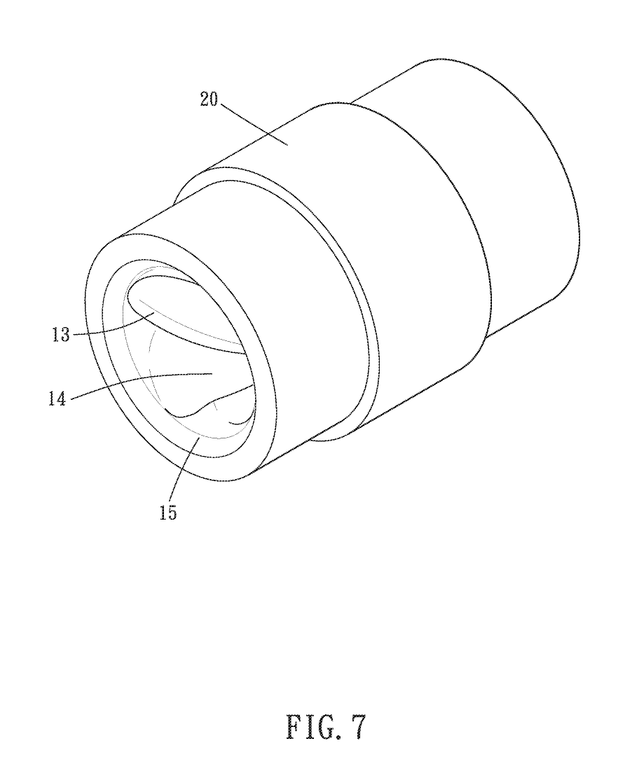

In the other embodiment, referring to FIGS. 1-6 in view of FIG. 7, the fluid acceleration pipe of the present invention can further include an outer sleeve 20. The outer sleeve 20 is sleeved onto the main body 10 and is rotatable with respect to the main body 10. Preferably, a bearing (not shown in drawings) is arranged between the outer sleeve and the main body for facilitating the rotation of the outer sleeve with respect to the main body. In practice, the bearing can be a ball bearing, a means of magnetic repulsion (e.g. magnetic flotation), or others.

In use, the fluid acceleration pipe of the present invention can be utilized in a variety of machines or pipes, such as air compressor. Fluid can be accelerated when flowing through the pipe cavity.

In conclusion, the fluid acceleration pipe of the present invention can effectively accelerate the fluid flowing therethrough. Thus, fluid in high speed and high pressure can be provided easier, and energy can be saved.

What is claimed is:

1. A fluid acceleration pipe, including a main body, the main body having a pipe cavity and defining a central axis, a whole part of an inner surface of the main body being exposed to the pipe cavity, the main body being formed with at least 3 spiral ribs arranged spacedly along a perimeter direction of the main body, a spiral groove being formed between any two adjacent ones of the spiral ribs, an imaginary datum plane being defined by a most bottom portion of each spiral groove about the central axis, the imaginary datum plane being column-shaped, a projection of a most top portion of each spiral rib on the imaginary datum plane defining a spiral line, a lead angle of the spiral line being 50 to 60 degrees, the top portion of each spiral rib having a convex-arc-shaped surface, the bottom portion of each spiral groove having a concave-arc-shaped surface.

2. The fluid acceleration pipe of claim 1, wherein the lead angle of each spiral line is 53 to 56 degrees.

3. The fluid acceleration pipe of claim 1, wherein the main body further has a diverging portion at each of openings of the pipe cavity, the spiral ribs and the spiral grooves not extend to the diverging portions, an inner diameter of each diverging portion is larger than an inner diameter of the imaginary datum plane and is increasing outward.

4. The fluid acceleration pipe of claim 1, wherein a height of each spiral rib is defined as a distance from the top portion of the spiral rib to the imaginary datum plane, the height of each spiral rib is 0.15-0.27 times an inner diameter of the imaginary datum plane.

5. A fluid acceleration pipe, including an outer sleeve and a main body, the outer sleeve being sleeved onto the main body and being rotatable with respect to the main body, the main body having a pipe cavity and defining a central axis, a whole part of an inner surface of the main body being exposed to the pipe cavity, the main body being formed with at least 3 spiral ribs arranged spacedly along a perimeter direction of the main body, a spiral groove being formed between any two adjacent ones of the spiral ribs, an imaginary datum plane being defined by a most bottom portion of each spiral groove about the central axis, the imaginary datum plane being column-shaped, a projection of a most top portion of each spiral rib on the imaginary datum plane defining a spiral line, a lead angle of the spiral line being 50 to 60 degrees, the top portion of each spiral rib having a convex-arc-shaped surface, the bottom portion of each spiral groove having a concave-arc-shaped surface.

6. The fluid acceleration pipe of claim 5, wherein the lead angle of each spiral line is 53 to 56 degrees.

7. The fluid acceleration pipe of claim 5, wherein the main body further has a diverging portion at each of openings of the pipe cavity, the spiral ribs and the spiral grooves not extend to the diverging portions, an inner diameter of each diverging portion is larger than an inner diameter of the imaginary datum plane and is increasing outward.

8. The fluid acceleration pipe of claim 5, wherein a height of each spiral rib is defined as a distance from the top portion of the spiral rib to the imaginary datum plane, the height of each spiral rib is 0.15-0.27 times an inner diameter of the imaginary datum plane.

9. The fluid acceleration pipe of claim 5, wherein a bearing is arranged between the outer sleeve and the main body for facilitating the rotation of the outer sleeve with respect to the main body.
